(19) United States
(12) Patent Application Publication
(10) Pub. No.: US 2004/0059476 A1
(43) Pub. Date: Mar. 25, 2004

(54) Deep sea data retrieval apparatus and system

(76) Inventor: Christopher O. Nichols, Kemah, TX (US)

Correspondence Address: THE BOHN STRUCTURE LAW FIRM, RIVER OAKS TOWER, 3730 KIRBY DR., SUITE1200, HOUSTON, TX, 77098, US

(21) Appl. No.: 10/427,029

(22) Filed: Apr. 30, 2003

Related U.S. Application Data
(60) Provisional application No. 60/376,701, filed on Apr. 30, 2002.

(51) Int. Cl. G06F 17/00

(52) U.S. Cl. 701/21

(57) ABSTRACT

The present invention is a device and method of transferring data from an autonomous underwater vehicle to a control center located above. The system comprises a plurality of canisters designed to store a packets of data and transport that data to the surface where the system transmits the data to a control center receiver. A compressed lifting gas released into a balloon provides buoyancy to transport the canister from depth to surface. At the surface the balloon lifts an antenna to a sufficient altitude for reliable communication. After transmission of the data, the device releases the balloon and sinks to the sea floor.

### CROSS-REFERENCE TO RELATED APPLICATIONS

This application claims the benefit of U.S. Provisional Application No. 60/376,701, filed Apr. 30, 2002.

### STATEMENT REGARDING FEDERALLY SPONSORED RESEARCH OR DEVELOPMENT

Not Applicable.

### BACKGROUND OF THE INVENTION

1. Field of the Invention

The invention relates to an apparatus and method of transferring mid-mission data from autonomous deep-sea exploration and inspection devices to a control center using releasable information communication canisters.

2. Description of the Related Art

The use of autonomous vehicles is widely known in the field of underwater exploration and inspection. Autonomous units are used to study the ocean floor, currents and life forms. Commercial applications include exploration for a variety of minerals, to include diamonds, oil and gas. Autonomous vehicles are used to inspect and repair underwater pipelines, communication systems and other underwater equipment. Other applications include military minesweeping and hazardous rescue, recovery and salvage operations.

During a subsurface mission, an autonomous underwater vehicle collects data pertinent to the particular mission, whether the data concerns water temperatures or the integrity of a petroleum pipeline. The information is either immediately sent to a control station or stored in onboard electronic memory. Water is a poor medium for communication, except over short distances. If an operator urgently needs the information, a communication wire or fiber optic cable must be connected to the vehicle, either permanently with a tether or through providing a subsurface docking station module. Otherwise the data is recovered when the vehicle surfaces.

An alternative exploration means is to tow a remotely operated vehicle behind a support vessel. The tow cable and control lines can incorporate a communication line for data recovery. Though this method provides real-time, high-resolution data and works well at relatively shallow depths, operations at deep depth requires long lengths of cable that quickly become a substantial challenge to manage.

A self-propelled vehicle having just a communication and control tether is able to reduce the bulky cable connection between the exploration vehicle and the control vehicle, but this system reaches its limitations in deep-sea operations. In an article titled, Autonomous Underwater Vehicles, James G. Bellingham, Principal Research Engineer at MIT's Autonomous Underwater Vehicles Laboratory, published in The Global ABYSS: An Assessment of Deep Submergence Science in the United States, University-National Oceanographic Laboratory System, Deep Submergence Science Committee, in 1994, discloses that at depths exceeding 1000 meters the tether of a remotely operated vehicle dominates operational considerations. The article focuses on the advantages and prospects for use of autonomous vehicles, which at the time were rated to operate to depths of 6000 meters.

If it is not possible to maintain real-time communication with the autonomous vehicle, receiving frequent transfers of the recently obtained data is the next best alternative. In many situations the information being gathered by the vehicle is critical. If a device conducting an inspection of a pipeline detects a leak or other significant event, the cumulative delay for the completion of the mission, recovery of the vehicle, and analysis of the data, allow the effects of the problem to increase. Trimming the delay by even a couple hours is valuable.

Current systems employ docking stations, which are deployed by a cable to the operational depth of the vehicle. The vehicle is programmed to dock with a docking module when one is available during a mission. Once docked, communication is established through the docking interface and the data is transferred over the module cable. Disadvantages of such systems include the cost of locating a docking module in the vehicles mission field and the fixed nature of the docking station. In addition to the cost of the subsurface module and connecting cable, a support platform must be placed on location for the duration of module deployment, interfacing, and recovery.

Examples of prior art exploration systems, which take advantage of autonomous vehicles, follow:

U.S. Pat. No. 5,687,137 issued to Schmidt et al. on Nov. 11, 1997 discloses an apparatus and method of conducting oceanographic sampling using an array of vertical, stationary analysis buoys, which, by means of wireless modem, communicate with a control station and direct the operation of at least one underwater analysis vehicle, such vehicle having the capacity to collect and store data and optionally dock to a stationary buoy in order to transfer data to the control station and rated to a depth of 6700 meters.

U.S. Pat. No. 5,995,882 issued to Patterson et al. on Nov. 30, 1999 discloses an autonomous underwater vehicle system for ocean science measurement and reconnaissance, said vehicle possessing the capacity to collect and store data, as well as a global positioning system receiver, a radio transceiver and strobe electronics to determine and communicate location for recovery once the vehicle returns to the surface.

U.S. Pat. No. 6,167,831 B1 issued to Watt et al. on Jan. 2, 2001 discloses an autonomous underwater vehicle for performing subsurface operations comprised of a primary vehicle with a tethered, free-moving craft, such that the primary vehicle delivers the craft to an employment location where the deployed tethered craft performs work. A subsurface docking module is deployed to allow the primary vehicle to dock adjacent to the work site and receive communication and auxiliary power.

It would be an improvement to the art to provide a system for periodic transfers of discrete quantities of recently obtained data from a deep-sea autonomous underwater vehicle to a control center. Such periodic transfer of data would allow mission modification and/or permit timely response action to the data. It would be a further improvement for the system to not require support vehicles above the mission field except for deployment and recovery. Such a system must accomplish these improvements while using minimal power from the vehicle system and maintaining the vehicle's buoyancy characteristic.

### BRIEF SUMMARY OF THE INVENTION

Accordingly, the objects of my invention are to provide, inter alia, a data transfer system from a deep-sea data collection device that:

provides mid-mission transfer of packets of data from a collection device to a control center, thereby allowing analysis of the data during the mission and decreasing the time from data collection to use of the information;

provides the capacity to transfer a quantity of collected data in a single packet;

eliminates the urgency of immediate recovery of the vehicle upon completion of the mission thereby avoiding possible hazardous recovery conditions;

reduces or eliminates the need to have a surface support team;

eliminates the need for the vehicle to surface during its mission;

preserves the buoyancy characteristics of the vehicle to which it is attached;

preserves the collection vehicle's power supply;

transmits at some distance from the vehicle, preserving the secrecy of the vehicle's location; and

is self-scuttling upon transmission completion in order to avoid third-party retrieval.

Other objects of my invention will become evident throughout the reading of this application.

My invention is an apparatus and system for receiving packets of data from an underwater data collection system and transferring such packets of data via a disposable, self-contained canister. Each canister, upon receiving a data packet, is transported to the surface by a balloon deployed from the canister by a small buoyant gas generator. The balloon is tethered to the canister by a wire that may act as an antenna upon reaching the surface. Once the antenna clears the surface wave action a transponder in the device establishes contact and relays the packet of data to a control center. After transfer is complete, the buoyancy of the balloon is released and the entire canister sinks. The canisters may be loaded in a reusable pallet that secures to the vehicle. The pallet houses a communication link from the control unit on the vehicle to each canister. The entire system, including the pallet and the canister (until release) are constructed to be neutrally buoyant at depth (displacing a volume equal to its weight in water), so that they do not disturb the buoyancy profile of a particular underwater vehicle. The pallet is shaped to minimize drag when mounted to the underwater vehicle.

### BRIEF DESCRIPTION OF THE DRAWINGS

FIG. 1 is a cut-away side view of a canister in a stowed configuration.

FIG. 1A is a partial cross-sectional side view of a frangible pin retaining a canister cover to a canister in a stowed configuration.

FIG. 1B is an exploded view of the frangible pin connection of FIG. 1A.

FIG. 2 is a cut-away bottom view of a canister.

FIG. 3 is a block diagram depicting the components interfacing the canister processor.

FIG. 4 is a schematic side view of an autonomous underwater vehicle equipped with a pallet.

FIG. 5 is a schematic top view of a pallet without canisters.

FIG. 6 is a partially cut-away side view of a pallet housing canisters.

FIG. 7 is a schematic side view of a deployed canister.

FIG. 8 is a flow diagram depicting the processor control sequence.

### DESCRIPTION OF THE INVENTION

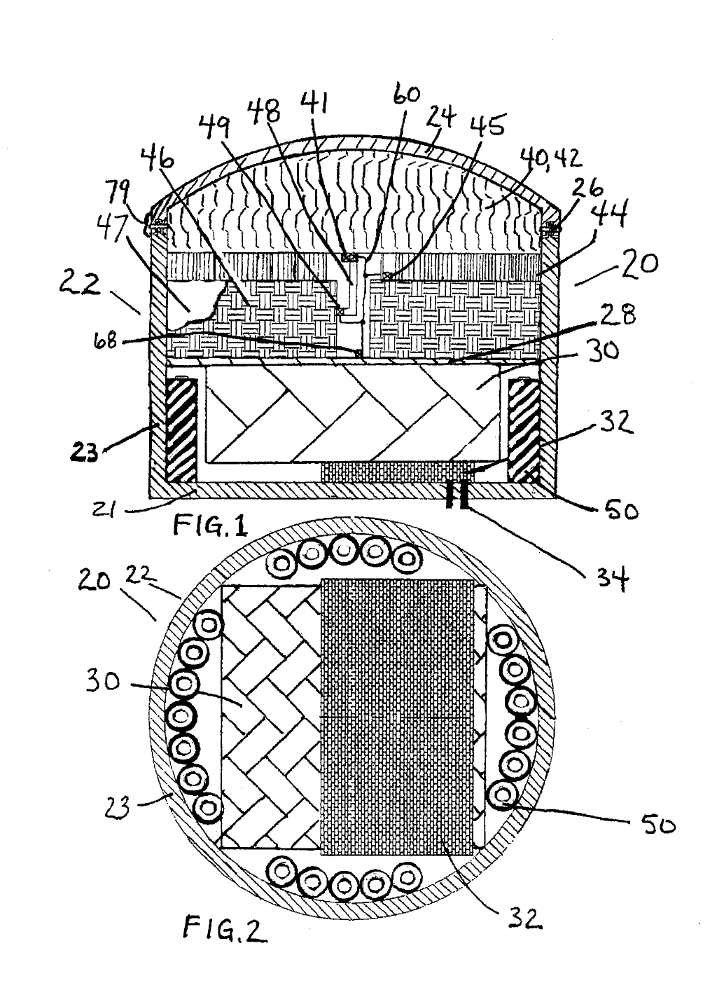

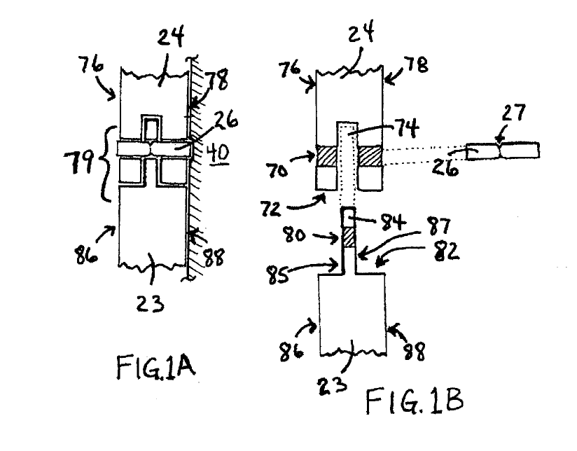

FIGS. 1 and 2 depict an exemplary data transfer canister 20 of the present invention. Within canister housing 22 is data storage module 32, electronics module 30, lifting gas container 46, balloon 40, tether 43 and power supply 50. Canister housing 22 has a shaped in order to withstand the extreme pressures of great depths. In the exemplary embodiment canister housing 22 has a cylindrical shape. Canister top 24 is shaped to reduce drag when moving through the water. In the exemplary embodiment canister top 24 has a dome shape. Data connectors 34, connected to data storage module 32 inside canister housing 22, penetrate canister housing 22 in a pressure and water resistant manner. In the exemplary embodiment data connectors 34 are formed into canister housing base 21 of canister housing 22.

Referring to FIGS. 1, 1A, 1B and 2, in a stowed configuration, canister top 24 of canister 20 is connected to the entire perimeter of canister housing side 23 at top connection 79. In the preferred embodiment, groove 74 runs around the entire bottom edge 72, intermediate top outer wall 76 and top inner wall 78 of canister top 24. Raised tongue 84 extends outwardly from the entire top edge 82 of canister housing side 23, intermediate housing outer wall 86 and housing inner wall 88. Groove 74 and tongue 84 are correspondingly shaped to provide a close, slidable fit.

Canister top 24 has a number of canister top holes 70 adjacent to bottom edge 72, passing from outer wall 76 to inner wall 78 through groove 74. Canister housing side 23 has corresponding canister housing holes 80 in raised tongue 84, passing from tongue outer wall 85 to tongue inner wall 87. Frangible pins 26 are shaped and sized to fit in the junction of canister top holes 70 and canister housing holes 80, securing canister top 24 to canister housing side 23. Each frangible pin 26 has weakening score 27, which promotes frangible pins 26 breaking when separating pressure is applied to top connection 79 of groove 74 and tongue 84.

Referring to FIGS. 1 and 1A, balloon 40 may be positioned tightly against canister top 24. Balloon 40 lays flat across the inside of top connection 79 acting as a waterproof membrane that supports the waterproof seal of top connection 79. Balloon 40 may be folded into canister 20 in a manner that allows initial balloon 40 expansion from the area around balloon release valve 41. Integral to balloon 40 may be antenna 42. Balloon 40 and antenna 42 are both connected to canister 20 by tether 43. Tether 43 may be a communication enabling wire 44 operatively connected to electronics module 30, which may have antenna 42 and transmitter/receiver 36.

Referring to FIG. 1, directly under balloon 40 in canister housing 22 may be tether 43. In the exemplary embodiment tether 43 is wound in order to minimize the volume tether 43 collectively occupies and to provide uniform support against balloon 40 as deep-sea pressures compress against canister 20. Tether retainer 45 clamps to tether 43 in order to keep the bulk of tether 43 in container 20 until container reaches the water surface.

Beneath tether 43 is lifting gas container 46. Lifting gas container 46 is securely anchored to inner wall 88 of canister housing side 23. Gas valve 49 connects gas fill line 48 to lifting gas container 46. The other end of gas fill line 48 connects to balloon 40 at balloon release valve 41. In the exemplary embodiment lifting gas container 46 is a pressure vessel and lifting gas 47 is helium, pressurized sufficiently to overcome ambient pressures at operating depth. Other gasses, stored and delivered in various methods, can be used without deviating from the invention.

Referring to FIGS. 1 and 2, beneath lifting gas container 46 is waterproof partition 28. Waterproof partition 28 seals to the perimeter of canister housing side 23. Control wiring 60 passes through waterproof partition 28 connecting electronics module 30 to balloon release valve 41, tether retainer 45, gas valve 49 and depth sensor 68.

In the exemplary embodiment, beneath waterproof partition 28 are an electronics module 30, data storage module 32 and power supply 50. Exemplary power supply 50 is positioned around the periphery of the interior of canister housing side 23. In this manner power supply 50 allows room for the other components. In the exemplary embodiment, power supply 50 comprises multiple batteries resting on canister housing base 21 and against canister housing side 23. In the exemplary embodiment, twenty AA batteries provide sufficient energy for canister 20 to complete a data transfer mission. Twenty-three batteries are depicted in the exemplary embodiment to ensure energy requirements are met. Power supply 50 can be other independent energy sources without deviating from the invention.

Data storage module 32 provides a stable storage medium for data transferred to canister 20. In the exemplary embodiment, data storage module 32 is a compact four-gigabyte harddrive, positioned against canister housing base 21. Other types of data storage mediums can be used for data storage module 32.

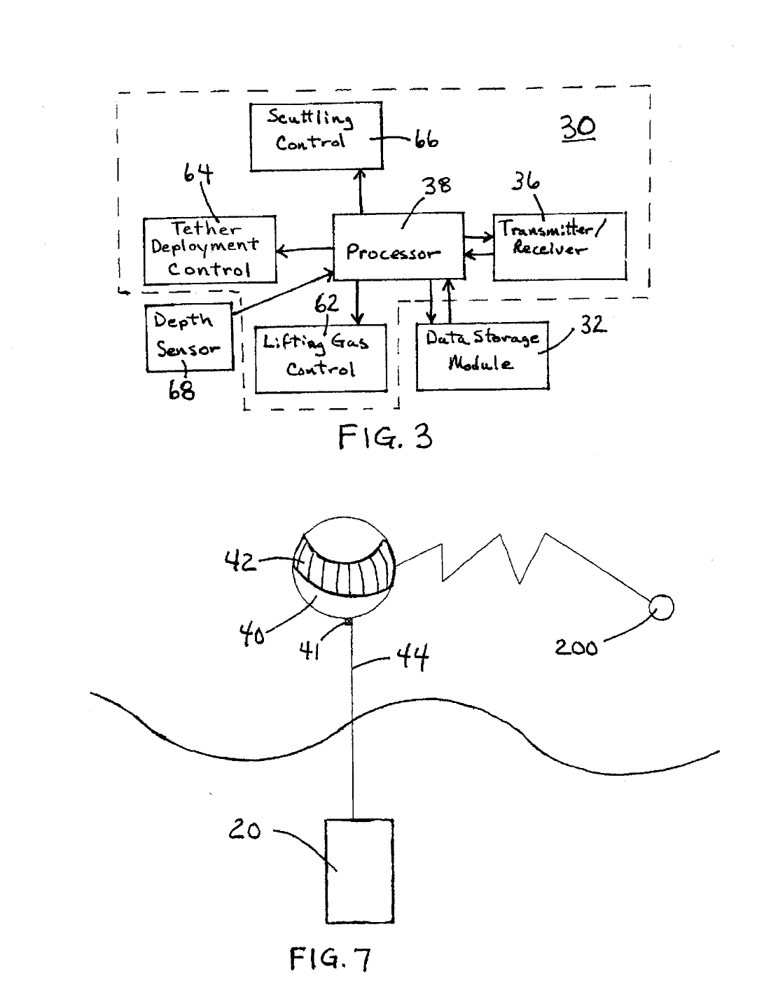

Referring to FIGS. 1, 2 and 3, electronics module 30 is positioned adjacent to data storage module 32 in order to minimize connection distance, and may be a circuit card. Electronics module 30 may comprise processor 38, transmitter/receiver 36, lifting gas control 62, tether deployment control 64 and scuttling control 66.

Processor 38 controls the operation of canister 20. Processor 38 is wired to data storage module 32 in order to both send and receive instructional and data signals. Processor 38 is also wired to transmitter/receiver 36 to both send and receive instructional and data signals. Processor 38 is wired to send instructional signals to lifting gas control 62, tether deployment control 64 and scuttling control 66.

Lifting gas control 62 initiates releasing lifting gas 47 into balloon 40, through gas fill line 48. In the exemplary embodiment lifting gas control 62 opens gas valve 49, attached as the interface between lifting gas container 46 and gas fill line 48.

Depth sensor 68 detects when canister 20 reaches the water surface. In the exemplary embodiment, depth sensor 68 is a pressure sensor set to detect one atmosphere of pressure, or the pressure at sea level.

Tether deployment control 64 initiates releasing the entire length of tether 43, which secures balloon 40 to canister housing 22. In the exemplary embodiment tether deployment control 64 releases tether retainer 45, which is secured to lifting gas container 46. Tether retainer 45 keeps the bulk of tether 43 within canister housing 22 until canister 20 reaches the water surface.

Scuttling control 66 initiates a signal to the tether retainer 45 to cut tether 43, breaking the connection of balloon 40 and canister housing 22. In that canister 20 is negatively buoyant without inflated balloon 40, canister 20 sinks to the bottom. Scuttling control 66 can be deactivated if canister recover is desired.

Referring to FIGS. 1, 4 and 5, canisters 20 are attached to the top of underwater vehicle 100 mounted to pallet 10. Pallet 10 is shaped to minimize drag on vehicle 100.

Pallet 10 releasably holds canisters 20 in canister wells 12, with data connectors 34 in place against canister contacts 18. Canister contacts 18 are connected to pallet control unit 14 through wiring harness 16. Control unit 14 connects to vehicle processing unit 102 through the coupling of vehicle transfer wire 104 and pallet transfer connection 106. Vehicle processing unit 102 is a processing unit of the autonomous underwater vehicle 100, which has been programmed to transfer a copy of data collected over a period of time. Pallet 10 may be reusable by reloading canister wells 12 with other stowed canisters 20.

Referring to FIGS. 1, 2, 3 and 7, each processor 38, lifting gas control 62, tether deployment control 64, and scuttling control 66, of electronic module 30, and data storage module 32 operate off the individual power supply 50 in each individual canister. Each processor 38 controls the sequential activity of that one canister 20 during operation.

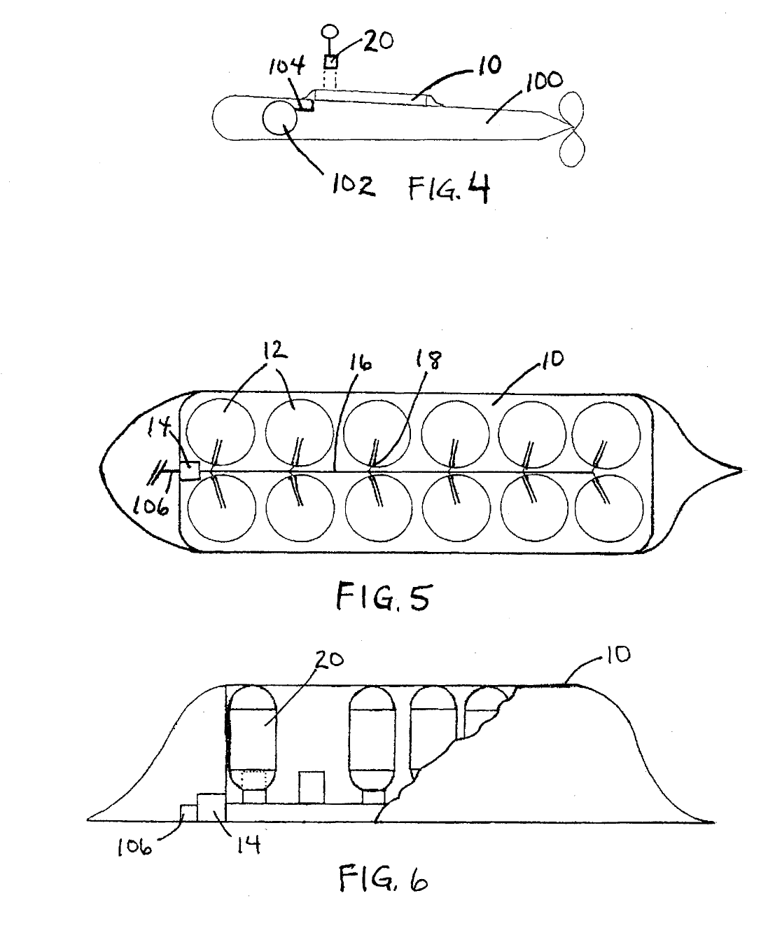

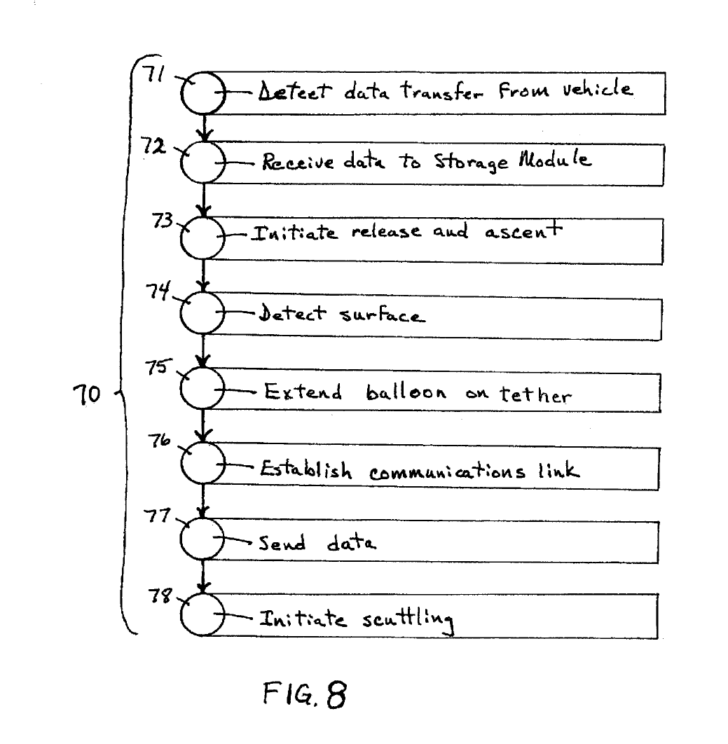

Referring to FIGS. 1 through 7, when the programming of vehicle processing unit 102 identifies that the allotted time has passed or the allotted quantity of data has been collected, vehicle processing unit 102 attempts to transfer a copy of that data as a packet to the next canister 20 in pallet 10. The data signal is sent over transfer wire 104 to transfer connection 106 to pallet control unit 14. Control unit 14 routes the signal to the next canister 20 in sequence. In the exemplary embodiment, control unit 14 is a passive router that uses the energy of the transfer signal, thereby minimizing energy use. Detecting (71) a transfer signal from vehicle processing unit 102 initiates processor control sequence 70 in that particular canister 20.

The steps of processor control sequence 70 are as follows. Detecting (71) data transfer from vehicle processing unit 102. Receiving (72) the data from vehicle processing unit 102 and storing in data storage module 32. Initiating (73) release of lifting gas 47 into balloon 40, causing canister 20 to become buoyant and release from pallet 10, leaving canister well 12. Detecting (74) surface with signal from pressure sensor 68. Extending (75) balloon 40 on the full length of tether 43 by releasing tether retainer 45. Establishing (76) communications link with control receiver 200 by transmitter/receiver 36 transmitting a “lock-on” signal until control receiver 200 acknowledges. Sending (77) data contained in data storage module 32 by transmitter/receiver 36, through wire 44 and antenna 42. Initiating (78) scuttling, which completely releases tether retainer 45, disengaging tether 43 from balloon 40.

In order to control the use of energy, electronics module 30 may not activated until processing unit 102 completes sending data to canister 20.

Once balloon 40 sufficiently expands, frangible pins 26 holding top 24 to walls 22 break and the volume of balloon 40 may expand beyond boundaries of canister 20. As balloon 40 expands, the positive buoyancy increases, accelerating canister 20 towards the surface. Balloon 40 separates a distance from canister 20, attached to tether 43. Tether retainer 45 may prevent deployment of the entire length of tether 43. Enough tether 43 is freed to provide a distance sufficient to prevent inadvertent contact between balloon 40 and canister 20 that could damage balloon 40. The bulk of tether 43 is secured within canister 20 by tether retainer 45, which in the exemplary embodiment is secured to lifting gas container 46.

Once canister 20 is at the surface and tether retainer 45 releases the bulk of tether 43, balloon 40 ascends to an altitude of the full length of tether 43. In the exemplary embodiment that height is 100 feet (˜30.5 m). Antenna 42 on balloon 40 is above wave action and has a clear transmission path to control receiver 200 for a control center (not shown). In the exemplary embodiment transmitter/receiver 36 operates on ultrahigh frequency (UHF), which is compatible with ground or satellite operation.

Alternately, canister 20 can be programmed to receive signals to retransmit data or to the data from data storage module 32. An alternate embodiment (not shown) of scuttling control 66 initiates a charge (not shown), destroying the data on data storage module 32. Other scuttling devices and techniques can be used, separately or in combinations.

Various alternate embodiments may be arranged for the disclosed components of canister 20. In an alternate exemplary embodiment (not shown), lifting gas container 46, gas valve 49 and part of gas fill line 48 is housed on pallet 10. Gas fill line 48 operatively connects to each balloon 40 on each canister 20. In this configuration, a part of gas fill line 48 contained in canister 20 may have a one-way flow valve, to permit lifting gas to enter balloon 40. In this embodiment, gas valve 49 may be controlled by vehicle processing unit 102 to sequentially supply a quantity of lifting gas to a particular canister 20 during the initiating (73) release step of each particular canister 20.

In an alternate exemplary embodiment, electronics module 30 and data storage module 32 may be of sufficiently little weight so as to be integrated into balloon 40. In this embodiment, balloon 40 may serve as water-proof section, protecting electronics module 30 and data storage module 32 from the sea elements.

Currently, a four-gigabyte harddrive meets the anticipated requirements for data storage module 32 for the operation of canister 20, in order to transfer one hour of data. The harddrive storage technology may include any variety of storage medium to include, but not be limited to magnetic or optical surface mediums, or flash memory mediums. It is anticipated that technological advancements will increase the options and capabilities of data storage module 32, as well as data collection. These advancements in data handling technology are anticipated and are within the scope of this invention. The exemplary embodiment is designed to transfer data packets in one-hour increments. Depending on the length of a vehicle 100 mission, these increments can be increased or decreased. Additionally, pallet 10 can be adapted to mount on the sides or bottom of vehicle 100.

The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

I claim:

1. An apparatus for relaying data from a deep-sea data collection system up to a control center, said apparatus comprising:
at least one canister, at least one lifting gas supply and at least one gas valve;
each said canister comprising a canister housing, a data storage module, an electronics module, a balloon, a balloon tether and a power supply;
each said canister housing shaped to resist extreme pressure of great depth;
each said canister housing releasably attachable to said deep-sea data collection system;
each said canister housing having a water-proof section capable of resisting deep-sea fluid pressure levels;
at least one said data storage module and at least one said electronics module within each said water-proof section;
each said data storage module operatively connectable to said deep-sea data collection system;
each said data storage module operatively connected to a corresponding said electronics module;
each said electronics module operatively connected to a corresponding said gas valve and a corresponding said power supply;
each said balloon tether secured intermediate one said balloon and one said housing; and
each said gas valve operatively connected to one said lifting gas supply and at least one said balloon.

2. The apparatus as in claim 1 further comprising:
each said balloon having an interior; and
each said interior defining said water-proof section.

3. The apparatus as in claim 1 further comprising:
each said canister having a stowed configuration and a deployed configuration; and
each said canister being neutrally buoyant in said stowed configuration.

4. The apparatus as in claim 1 further comprising:
each said housing having a rigid, generally cylindrical shape, and a first end; and
each said first end rigidly occluded.

5. The apparatus as in claim 4 further comprising:
each said housing having a second end;
each said housing open at said second end;
each said second end having an end perimeter; and
a canister top correspondingly sized to releasable attach to a corresponding said end perimeter.

6. The apparatus as in claim 1 further comprising:
each said electronics module comprising a transmitter/receiver and a processor;
each said transmitter/receiver operatively connected to a corresponding said processor and a corresponding said data module; and
each said transmitter/receiver capable of relaying data from said corresponding said data module to a control receiver for said control center.

7. The apparatus as in claim 6 further comprising:
each said balloon having an antenna; and
each said tether operatively connected to a corresponding said antenna and a corresponding said electronic module.

8. The apparatus as in claim 6 further comprising:
each said balloon having an interior; and
each said interior defining said water-proof section.

9. The apparatus as in claim 6 further comprising:
each said electronics module comprising a lifting gas control; and
each said lifting gas control operatively connected to a corresponding said processor.

10. The apparatus as in claim 9 further comprising:
each said lifting gas control operatively connected to a corresponding said gas valve; and
each said lifting gas control capable of affecting an introduction of a lifting gas into a corresponding said balloon.

11. The apparatus as in claim 6 further comprising:
each said electronics module comprising a tether deployment control; and
each said tether deployment control operatively connected to a corresponding said processor.

12. The apparatus as in claim 11 further comprising:
each said tether deployment control operatively connected to a tether retainer; and
each said tether deployment control capable of affecting a controlled release of a corresponding said tether by a corresponding said tether retainer.

13. The apparatus as in claim 6 further comprising:
each said electronics module comprising a scuttling control; and
each said scuttling control operatively connected to a corresponding said processor.

14. The apparatus as in claim 13 further comprising:
Each said scuttling control capable of affecting deflation of a corresponding said balloon.

15. The apparatus as in claim 13 further comprising:
each said scuttling control capable of disconnecting a corresponding said balloon from a corresponding said housing.

16. The apparatus as in claim 1 further comprising:
a pallet;
said pallet attachable to said deep-sea data collection system;
said pallet having at least one canister well; and
said pallet capable of releasably holding at least one stowed canister.

17. The apparatus as in claim 16 further comprising:
said pallet housing said lifting gas supply.

18. A method for relaying data from a deep-sea data collection system up to a control center, said method comprising:
storing data in a data storage module, said data storage module and an electronics module within a water-proof section of a canister housing, said water-proof section capable of resisting deep-sea fluid pressure levels, and said canister housing releasably attachable to said deep-sea data collection system;
increasing a buoyancy of said canister housing; and
releasing said canister housing from said deep-sea data collection system.

19. The method of claim 18 further comprising:
said increasing a buoyancy step comprising inflating a balloon with a lifting gas, said balloon secured to a balloon tether, and said balloon tether secured to said canister housing.

20. The method of claim 18 subsequently further comprising:
transferring said data from said data module to a control receiver for said control center.

21. The method of claim 20 wherein said transferring said data step further comprising:
establishing communication link with said control receiver for said control center; and
sending data.

22. The method of claim 20 subsequently further comprising:
scuttling said water-proof section.
